(19) United States
(12) Patent Application Publication
(10) Pub. No.: US 2010/0038323 A1
(43) Pub. Date: Feb. 18, 2010

(54) DEVICE AND METHOD FOR TREATING BALLAST WATER WITH UV- RADIATING MEANS AND CATALYSTS

(75) Inventors: David Stenman, Enebyberg (SE); Per Borin, Nacka (SE); Emil Eriksson, Stockholm (SE); Carl Tullstedt, Saltsjo-boo (SE)

Correspondence Address: YOUNG & THOMPSON, 209 Madison Street, Suite 500, Alexandria, VA, 22314, US

(73) Assignee: ALFAWALL AKTIEBOLAG, Tumba (SE)

(21) Appl. No.: 12/442,826

(22) PCT Filed: Sep. 25, 2007
(86) PCT No.: PCT/SE07/50676

§ 371 Date: Jun. 2, 2009

(30) Foreign Application Priority Data
Sep. 25, 2006 (SE) 0601999-6

(51) Int. Cl. B63J 4/00; C02F 1/32

(52) U.S. Cl. 210/747; 210/170.11

(57) ABSTRACT

A device and method for treating ballast water, including an enclosure having LJV radiating elements, and catalysts include a number of plates having turbulence and mixing generating elements characterised in that the catalyst plates are arranged in the enclosure, and that the catalysts having turbulence and mixing generating elements selected from one or more of the elements from the group consisting of perforations, holes, punchings, structured pressings, corrugations, and grooves. A system for treating ballast water in a ship is also disclosed.

### TECHNICAL AREA

The present invention relates to a method for treating liquids, and in particular purifying liquids in order to remove or destroy harmful organisms in the liquid with photo-catalytic reactions.

### TECHNICAL BACKGROUND

There is a greater and greater demand on the environmental effects of polluted liquids and in particular water. The access to clean and unpolluted water has become a major issue in the world. This entails both fresh water as well as salt water. The fresh water supply in many areas of the world is limited at the same time as many of the fresh water sources are polluted by man.

Regarding salt water, for many decades all sorts of harmful and polluting substances have been dumped in the seas, such as chemicals, crude oil, petrol, heavy metal and soot from factory chimneys, which pollutants affect the delicate biological balance in the seas.

The biological balance in the seas has also been affected by man due to ballast water handling. Ships are arranged with ballast water tanks that are filled in order to stabilize them when the ships are not fully loaded with cargo. That is, when a ship has offloaded its cargo at a port in for instance the Black sea, and then receives instructions to pick up another cargo in a port in the Red sea, it fills its ballast water tanks with sea water from the Black sea. When the ship then reaches the port in the Red sea, it empties the ballast water tanks for receiving new cargo. Thus the species that were in the water of the Black sea have been transported to the Red sea. The transported species may be completely different from the normal species of the red sea and may thus cause large ecological problems. It is well known that species that are transported from their normal environment to a new environment can cause great problems, for example due to that they have no normal enemies in the new environment, that the local species obtain diseases from the transported species and are wiped out, etc. Some species that have been recognised as major ecological problem if spread are cholera, kelp, toxic algae and mussels, just to mention a few. It is estimated that about 3-5 billion tonnes of ballast water are transported around the world. It is thus not surprising that this has become a major issue where the International Maritime Organisation of UN has issued a convention that with start from 2009 will put demand on all commercial ships to be equipped with and use special systems for handling ballast water.

Many systems have been developed for treating and purifying water such as with chemicals where chloride is commonly used. In order to reduce the negative impact that many chemicals have on the environment, systems have been developed that do not use chemicals but rely on other effects in order to kill organisms in water in order to purify it.

Methods have been developed in several countries for purifying water with ozone (O₃) in drinking water installations and bathing facilities, and also ozone dissolved in water for cleaning, disinfection and sterilization of articles. The reaction capacity of ozone (2.07 V electrochemical oxidation potential) is ascribed to the fact that it is a powerful oxidant. The high chemical reactivity is coupled with the unstable electron configuration which seeks electrons from other molecules, which thus means that free radicals are formed. In this process, the ozone molecule is broken down. By means of its oxidizing effect, the ozone acts rapidly on certain inorganic and organic substances.

Its oxidizing effect on certain hydrocarbons, saccharides, pesticides, etc., can mean that ozone is a good choice of chemical in certain processes. A combination of ozone, oxygen, hydroperoxide and UV radiation means that the reaction proceeds much more quickly and more efficiently by virtue of the generation of more free radicals. The photolytic and photo-catalytic process is used to decompose the organisms, rendering them harmless, and for that purpose light with different wave lengths are used. One of the common spectras used is UV-light where certain wave lengths are more effective than others in creating the desired effect. For example, wavelengths below 200 nm have a good effect in creating ozone from the oxygen in the liquid, which ozone reacts with the organisms. In order to increase the effect some methods use additional oxygen to promote the creation of ozone.

Another method is to radiate the created ozone with UV light of a certain wave length in order to break down the ozone and create radicals, which are more aggressive than ozone. Such a method is disclosed in EP 0 800 407, in which the medium which is to be treated is introduced into some form of enclosure. In the enclosure, the medium is exposed to UV radiation with a spectral distribution within the range of 130-400 nm.

The wavelengths below 200 nm, in particular, convert the oxygen in the medium to ozone molecules (O₃). The ozone molecules formed are at the same time decomposed by radiation within the above-mentioned wavelength range, especially at wavelengths of −400 nm. At the same time, the O₂ formed is broken down to form atomic oxygen.

In order to increase the efficiency during generation of free radicals, in particular HO′ radicals, catalysts are utilized, arranged in the zone where the ozone is decomposed to free radicals. Materials used for the catalysts could comprise metal and/or metal oxides, such as noble metals, aluminium oxide, titanium oxide, silicon oxide and mixtures thereof.

In some areas of use, such as treating seawater having a high salinity level, the above-mentioned methods of creating and breaking down ozone did not work as good as expected because the chloride ions in the saltwater absorbed the UV wave length required for ozone formation.

### BRIEF DESCRIPTION OF THE INVENTION

The aim of the present invention is to utilize the combining positive effect of generating ozone, at the same time breaking down the ozone to form free radicals in an area where catalysts are present for boosting the generation of free radicals, which forms the basis of the invention according to EP 0 800 407, in a very efficient way in order to ensure very high degrees of purification and killing of organisms.

This aim is obtained by the features of the independent patent claims. Preferable embodiments of the present invention are found in the dependent patent claims.

According to a main aspect of the invention it is characterised by a device for treating ballast water, comprising an enclosure having UV radiating means, and catalysts comprise a number of plates having turbulence and mixing generating means characterised in that said catalyst plates are arranged in said enclosure, and that the catalysts having turbulence and mixing generating means selected from one or more of the means from the group consisting of perforations, holes, punchings, structured pressings, corrugations, and grooves.

According to another aspect of the invention, the catalyst plates are arranged such that the UV radiating means are going though the catalyst plates.

According to a further aspect of the invention, the UV radiating means are radiating light within the range from about 130 to about 400 nm.

Preferably the UV radiating means are radiating light in at least the regions of 187 nm and of 254 nm.

According to yet an aspect of the invention, the catalysts comprise metal, metal oxides or both, such as noble metals, aluminium oxide, titanium oxide, silicon oxide and mixtures thereof.

According to another aspect of the invention, the device also comprises UV light reflecting means.

According to one embodiment, the UV light reflecting means are means made of PTFE.

According to a further aspect of the invention, said UV generating means comprises UV lamps, that said UV lamps are arranged in elongated UV permeable tubes, and that said tubes are arranged generally transversal to the direction of flow of the liquid.

According to one embodiment of the invention, said catalysts comprises a number of plates arranged in stacks with certain distance between each plate, with said lamps arranged through said stacks, wherein the extension of said plates generally coincide with the direction of flow of the liquid.

According to yet an aspect of the invention, there are a number of lamps arranged in said enclosure, that each lamp is arranged through a stack of plates, and that there is a distance between each stack, enabling turbulence and mixing of the liquid when entering and leaving said stacks.

According to yet an aspect of the invention, said plates have a cross-sectional design such that the leading edges are sharp and the trailing edges are blunt.

The present invention has a number of advantages in comparison with the known devices in this technical area. The very effective method of creating ozone and at the same time decomposing the ozone into free radicals with the use of catalysts is combined with very thorough mixing and turbulence in order to ensure that every volume of the liquid passing though the reactive zone is exposed to free radicals, providing a very complete treatment. The turbulence and mixing is obtained by many components according to the invention. The positioning and shape of the lamps is one component; the arrangement of the catalysts both in relation to the lamps and to the direction of flow as well as the shape, surface design also add to the thorough mixing, and in this aspect the prevention of dead zones close to the catalyst surfaces where the radicals are the most potent. It is thus important the transportation of light from the lamps to the active surfaces of the catalysts, the transport of organisms to the vicinity of the surfaces and the transportation of radicals from the surfaces to the liquid volume is optimized.

Because at least selected parts of the interior surfaces are arranged with reflection increasing means, the UV radiation emitted from the UV radiation generating means is used to a much higher degree than if some of the UV radiation is absorbed, which thus leads to a more efficient treatment process. Further, the required power is reduced.

The inner surfaces could be covered by suitable materials, that have reflection increasing properties. Preferably the materials also have properties to withstand the tough conditions inside the treatment unit and the aggressive effects from the liquid to be treated. The materials should also be effective against scaling, which otherwise would reduce the reflection effect during use.

These and other aspects of and advantages with the present invention will become apparent from the following detailed description and the accompanying drawings.

### BRIEF DESCRIPTION OF THE DRAWINGS

In the detailed description, reference will be made to the accompanying drawings, of which

FIG. 1 is an overview of a system for treating ballast water, including the present invention,

FIG. 2 shows schematically one feasible embodiment of a treatment unit according to the present invention,

FIG. 3 shows an example of design of a stack of catalytic plates comprised in the present invention,

FIG. 4 shows an example of design of a catalytic plate,

FIG. 5 shows another example of design of catalytic plates, and

FIG. 6 shows yet an example of a stack of catalytic plates of a certain shape.

### DETAILED DESCRIPTION OF THE INVENTION

An embodiment of the present invention will now be described in connection with the drawings. The present invention makes use of so called advanced oxidation technology (AOT) for water treatment utilizes short lived radicals to react with organic substances. AOT may as one application be used to treat ballast water in the ballast tanks of a ship.

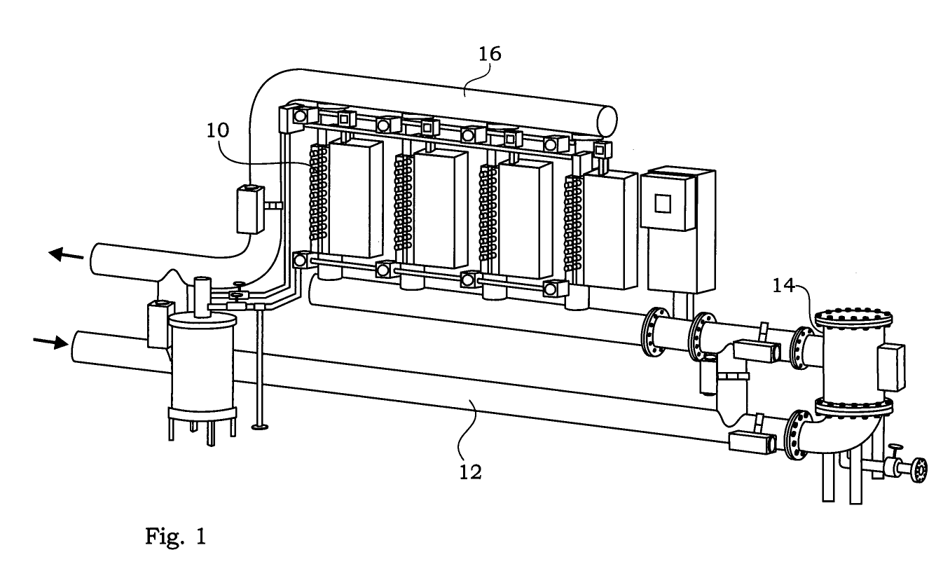

FIG. 1 shows schematically a system for treating ballast water including an AOT purifier 10. The water entering the system from the sea is pumped via an inlet pipe 12 through a filter 14, which removes larger components and substances contained in the water. The water then passes through the AOT purifier 10 before it enters the ballast tanks via outlet pipe 16.

The AOT purifier utilizes three important components for treating water flowing through the unit. One is UV-generating means, i.e. wavelengths within the ultraviolet spectra, <380 nm, of energies sufficient for photo catalysis and/or direct elimination of micro-organisms and/or direct formation of free radicals in the liquid or components dissolved therein and/or direct formation of ozone from oxygen present as gas or dissolved in the liquid. The wavelengths enable the second component which is generating of ozone in the water and at the same time breaking down the ozone to form free radicals. The third component is arranging catalysts in the reactive zone where ozone and free radicals are produced, in order to increase the amount of free radicals.

One very important aspect that the present invention deals with is to expose all the water flowing though the unit to the above treatment, i.e. to purify all water flowing. In order to achieve this it is very important to expose all volumes to the three above components, i.e. to ascertain that all volumes of water will pass through the above mentioned reactive zone or zones. Below is described a number of aspects of the present invention that will achieve this, where the main aim is to have a very good mixing of the water flowing.

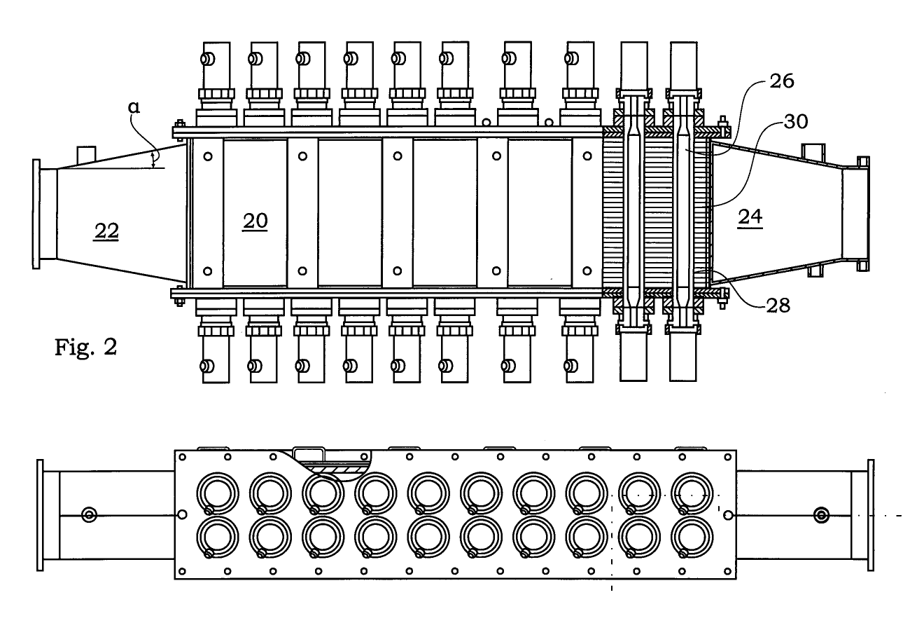

According to the embodiment shown in FIG. 2, the AOT purifier comprises a housing 20, in the shown embodiment as a generally elongated enclosure with a rectangular cross-section and with in- and outlets 22, 24 at each end of the enclosure. When water is flowing in the enclosure it will flow in the direction of the elongated enclosure between the inlet and the outlet. In the enclosure a number of UV radiating light sources 26 are arranged in elongated tubes of quartz glass 28, which extend between the opposite walls of the compartment. The light sources are connected to suitable power supply. The UV radiating light sources are chosen such that it emits wave lengths in the region of 130-400 nm for converting oxygen in the medium to ozone molecules (O3) and for decomposing the ozone molecules.

According to one aspect of the invention, the interior surfaces of the enclosure are arranged with reflection enhancing means. Either selected parts of the interior surfaces are provided with reflection enhancing means or all inner surfaces. The reflection enhancing means provides a “reuse” of the UV light that is emitted from the lamps. This provides the effect that there is a much better effect in that light that hits the interior of the treatment unit is reflected and continues to treat the liquid. There is thus no absorption of light, whereby the power required for the UV lamps is reduced.

There are a number of materials that might be suitable as reflection enhancing means. One important factor is that the material has to be able to withstand the rather aggressive conditions inside the unit, such as corrosion resistant properties and the like.

Materials that have proven successful are some polymeric materials, and in particular fluoroplastic such as polytetrafluoro ethylene (PTFE). PTFE has very high reflection capabilities and is thus suitable as a reflection enhancing material. Besides that, PTFE displays very low friction coefficient and is also resistant against aggressive liquids such as seawater. This will reduce or even eliminate the scaling and will also reduce the hydraulic friction trough the treatment unit. In this context, it is to be understood that other polymeric materials displaying similar properties can be used instead of PTFE. Polymeric materials are also much cheaper than steel or other metals. Further, the polymeric material could be prepared with catalytic material in for example powder form dispersed in the polymer, such as for example metal and/or metal oxides, such as noble metals, aluminium oxide, titanium oxide, silicon oxide and mixtures thereof.

### Arrangement of Lamps

The glass tubes are arranged substantially perpendicular to the direction of flow. In the embodiment shown in FIG. 2 the lamps are arranged in two rows, but there could be only one row as well, or more than 2 rows depending on the energy demands. It is to be understood from the following description that the positioning of the lamps could be made in other ways, such as staggering, i.e. subsequently displaced in the direction of flow. The lamps could also be radially indexed if the housing is a cylindrical unit. The important thing is that the positioning of the lamps causes a turbulent flow and generates vortex and turbulent mixing. In this context, it is also feasible that the lamp sleeves have shapes other than circular in cross-section, that increases the mixing, such as triangles, polygons, ovals, stars, for example.

### Arrangement of Catalysts

Further a number of plates 30 are arranged in the enclosure, the extension of which coincide with the direction of flow and thus perpendicular to the extension of the lamps. The plates are arranged in stacks with a certain distance between them. The plates act as catalysts for the AOT process thus boosting the amount of radicals produced. The plates are thus made of a material with catalytic properties to increase the number of radicals produced in the reactive zones. The material could include metal and/or metal oxides, such as noble metals, aluminium oxide, titanium oxide, silicon oxide and mixtures thereof.

The number of plates and the distance between them are chosen such that an optimization is obtained regarding e.g. transportation of light from the lamps to the active surfaces of the plates; transportation of organisms in the vicinity of the surfaces; and transportation of free radicals from the surfaces into the liquid volume.

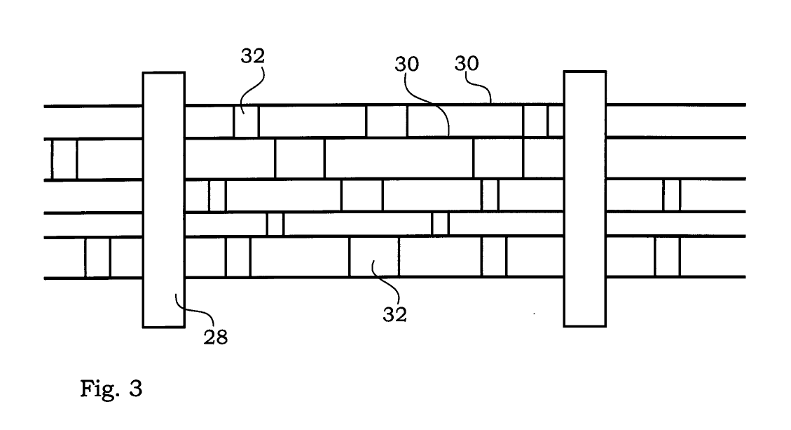

In order to further increase the turbulence and mixing of the liquid, extra obstacles 32, FIG. 3, such as cylinders may be implemented between the lamps and attached to the plates, which also act to ensure the correct distance between the catalyst plates. The lamps and obstacles could be placed with different distances to each other and/or having different sizes in order to create asymmetry and thus pressure differences between different volumes in the reactor, thereby creating a mixing. The asymmetry could be created both in the flow direction and transverse to the flow direction. In this aspect the extra obstacles in the flow direction could have different width or diameter such that every second obstacle is thinner and every other obstacle is thicker. The obstacles could also have other cross-sectional shapes such as triangles, polygons, ovals, stars, for example. Further, the obstacles could be arranged with reflecting material, such as flouroplastic, acrylic plastic and the like polymers having such properties.

In view of the above, it should however be noted that the asymmetry has to be performed in a calculated way so that no dead zones are created or flow paths that are not exposed in the optimal way.

### Design of Catalysts

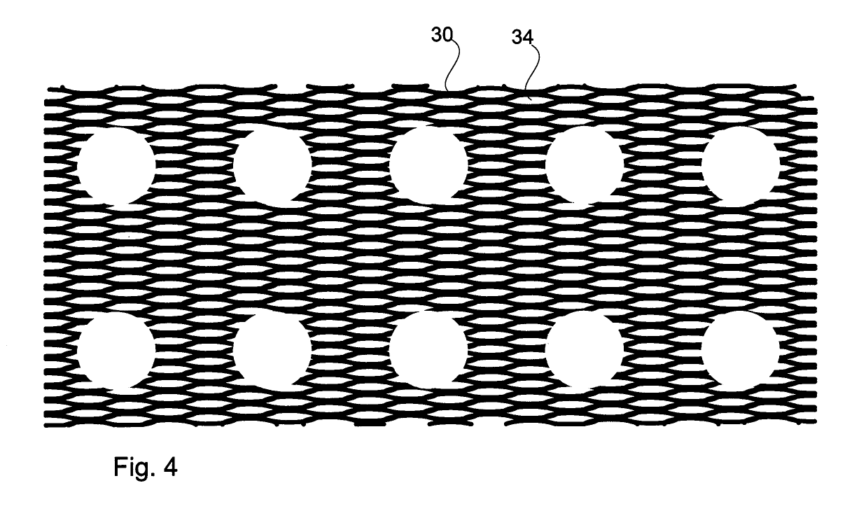

The catalyst plates are preferably designed to also increase and/or promote the turbulence in the reactive zones as well as designed to increase the surface area. There are a number of different designs, configurations and combinations of these that could be used. According to FIG. 4 the catalyst plates 30 are made of expanded metal, thus creating a number of perforations or holes 34 through the plates. One advantage with expanded metal is that the edges of the holes are sharp, thus increases the turbulence. Other types of designs could be punching, structure pressings, corrugations, grooves and the like. It is also conceivable to use nets, woven or non-woven fabrics, wire mesh and the like. These could further be made in light permeable material such as quartz glass, glass fibre or other materials having the right properties. The design of the surfaces of the plates and/or structure of the plates ensure that the boundary layer becomes very thin, which otherwise would prevent fluid exchange adjacent the photo catalytic surfaces of the plates, creating flow dead zones close to the surface where the radicals are the most potent. Other ways of decreasing the boundary layer could be to increase the surface rawness of the catalysts, by for example applying quartz sand to the surfaces.

### Size of Catalysts

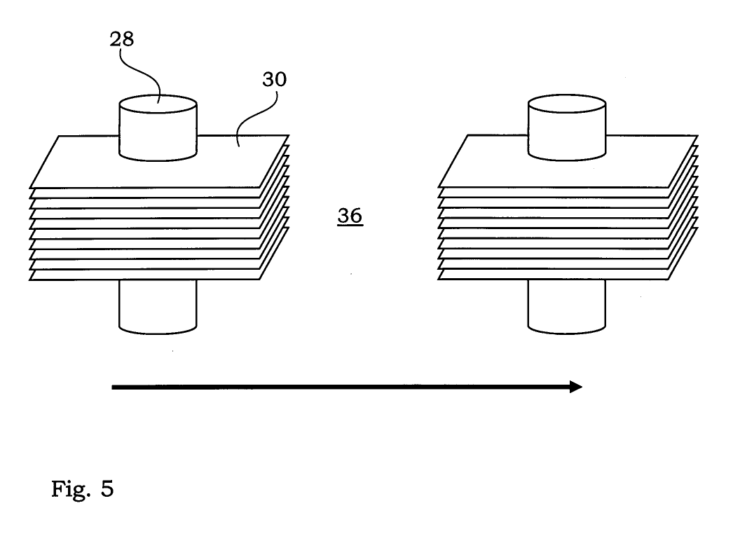

There are further measures that can be made in order to increase the turbulence and mixing. FIG. 5 show an embodiment where, in contrast to FIG. 2, the plates do not extend all through the enclosure but are “interrupted”, providing uninterrupted spaces 36 between the stacks of catalytic plates. This causes turbulence in the liquid when leaving a stack and further turbulence when hitting the subsequent stack so that a process, ->photo catalysis->mixing->photo catalysis->mixing, is obtained.

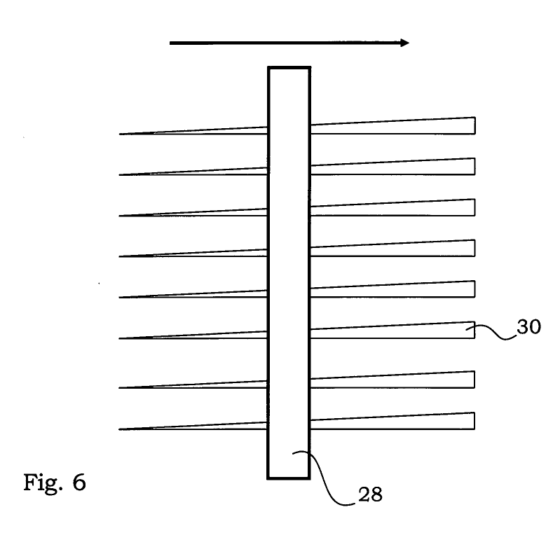

To even further enhance the turbulence when leaving a stack, the plates could have a cross-sectional design where the leading edge of each plate, i.e. facing the flow, is sharp, and where the trailing edge is blunt, FIG. 6.

There are other aspects that affect the efficiency of the device. For example the flow rate is one such aspect where a higher flow rate reduces the boundary layer. On the other hand, a too high flow rate might lead to volumes of ballast water passing through the treatment zones without being effectively treated. In this aspect it is important that the in- and outlet areas are designed in proper ways. Preferably the angles α, FIG. 2, of the inlet and outlet walls are less than 15° and preferably less than 7°. Further, the inlet and outlet areas could be arranged with guide plates for directing the liquid flow in desired directions.

It is to be understood that the embodiments of the invention described above and shown in the drawings are to be regarded only as non-limiting examples of the invention and that it may be modified in many ways within the scope of the patent claims.

1. A device for treating ballast water, comprising an enclosure having UV radiating means, and catalysts comprise a number of plates having turbulence and mixing generating means characterised in that said catalyst plates are arranged in said enclosure, and that the catalysts having turbulence and mixing generating means selected from one or more of the means from the group consisting of perforations, holes, punchings, structured pressings, corrugations, and grooves.

2. The device according to claim 1, wherein the catalyst plates are arranged such that the UV radiating means are going though the catalyst plates.

3. The device according to claim 1, wherein the UV radiating means are radiating light within the range from about 130 to about 400 nm.

4. The device according to claim 3, wherein the UV radiating means are radiating light in at least the regions of 187 nm and of 254 nm.

5. The device according to claim 1, wherein the catalysts comprise metal, metal oxides or both, such as noble metals, aluminium oxide, titanium oxide, silicon oxide and mixtures thereof.

6. The device according to claim 1, wherein the device also comprises UV light reflecting means.

7. The device according to claim 6, wherein the UV light reflecting means are means made of PTFE.

8. The device according to claim 6, wherein the UV light reflecting means further comprises catalytic material.

9. Device according to claim 2, characterised in that said UV generating means comprises UV lamps, that said UV lamps are arranged in elongated UV permeable tubes, and that said tubes are arranged generally transversal to the direction of flow of the liquid.

10. Device according to claim 1, characterised in that said catalysts comprises a number of plates arranged in stacks with certain distance between each plate, with said lamps arranged through said stacks, wherein the extension of said plates generally coincide with the direction of flow of the liquid.

11. Device according to claim 1, characterised in that there are a number of lamps arranged in said enclosure, that each lamp is arranged through a stack of plates, and that there is a distance between each stack, enabling turbulence and mixing of the liquid when entering and leaving said stacks.

12. Device according to claim 11, characterised in that said plates have a cross-sectional design such that the leading edges are sharp and the trailing edges are blunt.

13. System for treating ballast water in a ship, comprising piping connecting to a number of ballast water tanks, pumps for transporting the ballast water to and from said ballast water tanks and water surrounding the ship, characterised in that it further comprises a device according to claim 1.

14. (canceled)

15. A method for treating ballast water comprising radiation of the ballast water with ultra violet light (UV) having a wavelength within the range from about 130 to about 400 nm in presence of oxygen, and catalysts for formation of ozone and free radicals in reactive zones, wherein the catalysts comprise a number of plates which plates having turbulence and mixing generating means, mixing or creating turbulence by exposing the ballast water to the turbulence and the mixing generating means, which means are selected from one or more of the means from the group consisting of perforations, holes, punchings, structured pressings, corrugations, and grooves.
